(19) United States
(12) Patent Application Publication
(10) Pub. No.: US 2003/0020026 A1
(43) Pub. Date: Jan. 30, 2003

(54) Method of detecting pattern defects of a conductive layer in a test key area

(76) Inventors: Chao-Hui Huang, Hsin-Chu City (TW); Che-Kai Chan, Kao Hsiung Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 09/682,138

(22) Filed: Jul. 26, 2001

(51) Int. Cl. G21G 5/00

(52) U.S. Cl. 250/492.3

(57) ABSTRACT

A method of detecting pattern bridge defects between two conductive layers in a test key area on a semiconductor wafer, further comprising a plurality of active areas, begins with forming a first conductive layer in the test key area. A dielectric layer is then formed in the test key area to cover the first conductive layer with a plug hole formed in the dielectric layer to a surface of the first conductive layer. A conductive plug is formed in the plug hole thereafter. A second conductive layer and a third conductive layer, a distance away from the second conductive layer, are formed atop the conductive plug in the test key area, and on other portions of thedielectric layer in the test key area, respectively. Simultaneously a fourth conductive layer and a fifth conductive layer, separated by a distance equal to the distance that separates the second conductive layer and the third conductive layer, are formed in each of the active layers. An E-beam is employed to detect whether pattern bridge defects exist between the second conductive layer and the third conductive layer at the end of the method.

### BACKGROUND OF INVENTION

1. Field of the Invention

The present invention relates to a method of detecting pattern defects of a conductive layer in a test key area on a semiconductor wafer, and more specifically, to a method of detecting a bridge effect between two conductive layers in an active area by detecting pattern defects of the conductive layer in the test key area.

2. Description of the Prior Art

In semiconductor fabrication, a semiconductor device or an integrated circuit (IC) should bise continuously tested in every step so as to maintain device quality. Normally a testing circuit is simultaneously fabricated with an actual device so that the quality of the actual device can beis judged by a the performance of the testing circuit. The quality of the actual device therefore can beis well controlled.

A typical method to test a wafer is called a wafer acceptance testing (WAT) method, which can measure defects of thein a wafer. The WAT method includes providing several test keys distributed in a periphery region of a die, which that is desired to be tested. The test keys typically are formed on a scribe line between dies, and are electrically coupled to an external terminal through a metal pad. A module of the test keys is selected and each test key off the selected module is respectively used for a test of different property of the wafer, such as threshold voltage (V_{T}) or saturate current (ID_{SAT}). A controlled bias is applied to the test keys, and the induced current is read out to detect defects on the wafer. As the semiconductor integration processes turn more and more complicated, test keys are employed more and more often as well. It is therefore important to improve the accuracy of tests.

Normally pattern bridge defects, the phenomenon of two neighboring conductive layers electrically connected to each other, are detected by shooting an E-beam, generated by a scanning electron microscope (SEM), to a conductive layer within the test key area so as to obtain a voltage contrast figure. By comparing whether the voltage contrast figure shape of the two neighboring conductive layers in an observed test key area is consistent with that in other test key areas in shape, by using machine or the naked huaman eyes, pattern bridge defects of the two neighboring conductive layers in the observed test key areas can be detected. However, connected portions between the two neighboring conductive layers are often hard to be clearly observed by machine or the naked human eyes when so smalltiny. This leads to the misjudgment towards the quality of the conductive layers. Consequently, yield rates of subsequent processes are seriously impacted.

### SUMMARY OF INVENTION

It is therefore a primary objective of the present invention to provide a method of detecting pattern bridge defects between two conductive layers in a test key area on a semiconductor wafer so as to avoid the misjudgment towards tiny portions that connect the two conductive layers.

According to the claimed invention, a semiconductor wafer, comprising a silicon substrate, comprises a test key area and a plurality of active areas. At the beginning of the method, a first conductive layer is formed in the test key area. A dielectric layer is then formed in the test key area to cover the first conductive layer. A plug hole is formed in the dielectric layer to a surface of the first conductive layer thereafter, followed by the formation of a conductive plug in the plug hole. Then, a second conductive layer and a third conductive layer, a distance away from the second conductive layer, are formed atop the conductive plug in the test key area and on other portions of thedielectric layer in the test key area, respectively. Simultaneously, a fourth conductive layer and a fifth conductive layer, being separated by a distance equal to the distance that separates the second conductive layer and the third conductive layer, are formed in each of the active layers, the fourth conductive layer and the fifth conductive layer. At the end of the method, an E-beam generated by a scanning electron microscope (SEM) is employed to detect whether pattern bridge defects exist between the second conductive layer and the third conductive layer.

It is an advantage of the present invention that a first conductive layer is connected to the second conductive layer via the conductive plug. Thus when the second conductive layer is electrically isolated from the third conductive layer, the second conductive layer has a voltage contrast figure different from that of the third conductive layer in color due to a different bottom structure. By comparing the colors of the second and third conductive layers in the voltage contrast figure obtained by shooting an E-beam to the second and third conductive layers, pattern bridge defects between the second and third conductive layers in the test key area, as well as those between the fourth and fifth conductive layers in each active area, are easily detected, even the connecting portions between the second and third conductive layers are tiny. The misjudgment towards the quality of conductive layers caused by the naked human eye observation is thus prevented. Consequently, yield rates of subsequent processes are significantly improved.

These and other objectives of the present invention will no doubt become obvious to those of ordinary skill in the art after reading the following detailed description of the preferred embodiment, which is illustrated in the multiple figures and drawings.

### BRIEF DESCRIPTION OF DRAWINGS

FIG. 1 to FIG. 4 of schematic diagrams of detecting pattern bridge defects between two conductive layers in a test key area on a semiconductor wafer according to the present invention.

### DETAILED DESCRIPTION

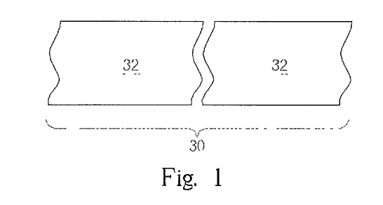

Please refer to FIG. 1 to FIG. 4 of schematic diagrams of detecting pattern bridge defects between two conductive layers in a test key area on a semiconductor wafer according to the present invention. As shown in FIG. 1, a semiconductor wafer 30 comprises a silicon substrate 32, further comprising a plurality of active areas and a test key area. For simplicity of description, an active area 34 and a test key area 36 are employed in FIG. 1.

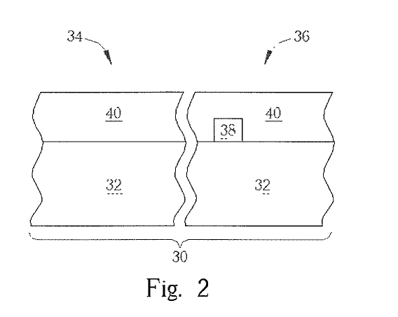

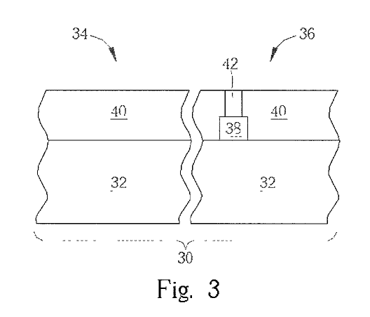

As shown in FIG. 2, a first conductive layer 38 and a dielectric layer 40 are respectively formed on portions of the silicon substrate 32 within the test key area 36. As shown in FIG. 3, a plug hole (not shown) is then formed in the dielectric layer 40 to a surface of the first conductive layer 38. A conductive plug 42 is formed in the plug hole thereafter.

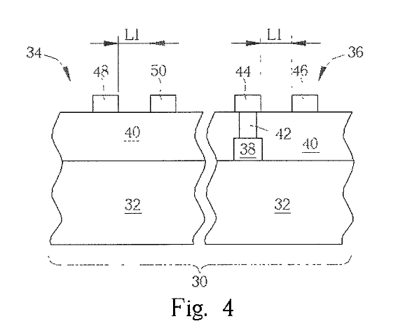

As shown in FIG. 4, a second conductive layer 44 and a third conductive layer 46, a distance of L₁ away from the second conductive layer 44, are formed atop the conductive plug 42 in the test key area 36, and on other portions of thedielectric layer 40 in the test key area, respectively. Simultaneously, a fourth conductive layer 48 and a fifth conductive layer 50 are formed in each of the active areas 34, and the fourth conductive layer 48 and the fifth conductive layer 50 are separated by the distance L₁ as well. The fourth conductive layer 48 and the fifth conductive layer 50, both in the active area 34, are formed by processes that are employed to form the second conductive layer 44 and the third conductive layer 46, both in the test key area 36. Thus the second conductive layer 44 and the third conductive layer 46 are employed to detect pattern bridge defects between the fourth conductive layer 48 and the fifth conductive layer 50, being separated by a distance L₁, in each active area 34.

Finally, an E-beam generated by a scanning electron microscope (SEM) is shot to the second conductive layer 44 to obtain a voltage contrast figure. Since the second conductive layer 44 is electrically connected to the first conductive layer 38 by the conductive plug 42, the voltage contrast of the second conductive layer 44 has a lighter color than the voltage contrast of the third conductive layer 46 when the second conductive layer 44 is electrically isolated from the third conductive layer 46. On the contrary, when pattern bridge defects exist between the second conductive layer 44 and the third conductive layer 46, the voltage contrast of the second conductive layer 44 has a color similar to that of the third conductive layer 46. Consequently, pattern bridge defects that exist between the fourth conductive layer 48 and the fifth conductive layer 50 are detected by comparing the color of the voltage contrast of the second conductive layer 44 to that of the third conductive layer 46.

In comparison with the prior art, a first conductive 38 layer is connected to the second conductive layer 44 via the conductive plug 42 so that the second conductive layer 44 has a different bottom structure from the third conductive layer 46 in the present invention. Thus the second conductive layer 44 has a voltage contrast figure different from that of the third conductive layer 46 in color when electrically isolated from the third conductive layer 46. By comparing the colors of the second conductive layer 44 and the third conductive layer 46 in the voltage contrast figure, pattern bridge defects between the second conductive layer 44 and the third conductive layer 46 in the test key area 36, as well as those between the fourth conductive layer 48 and the fifth conductive layer 50 in each active area 34, are easily detected, even if the connecting portions between the second conductive layer 44 and the third conductive layer 46 are tiny. The misjudgment towards the quality of conductive layers caused by the naked human eye in the prior art method is thus prevented. Consequently, yield rates of subsequent processes are significantly improved.

Those skilled in the art will readily observe that numerous modifications and alterations of the device may be made while retaining the teachings of the invention. Accordingly, the above disclosure should be construed as limited only by the metes and bound of the appended

What is claimed is:

1. A method of detecting pattern bridge defects between two conductive layers in a test key area on a semiconductor wafer, the semiconductor wafer further comprising a plurality of active areas and the test key area, the method comprising:
forming a first conductive layer in the test key area;
forming a dielectric layer in the test key area, the dielectric layer covering the first conductive layer;
forming a plug hole in the dielectric layer through to the a surface of the first conductive layer;
forming a conductive plug in the plug hole;
forming a second conductive layer atop the conductive plug in the test key area, and
forming a third conductive layer on the other portions of thedielectric layer in the test key area, from a distance of the second conductive layer and the third conductive layer in the test key area being separated by a distance, and simultaneously forming a fourth conductive layer and a fifth conductive layer in each of the active layers, the fourth conductive layer and the fifth conductive layer being separated by a distance equal to the distance that separates the that are with the same distance as the that between the second conductive layer and the third conductive layer in each of the active areas; and
using an E-beam to detect whether pattern bridge defects exist between the second conductive layer and the third conductive layer.

2. The method of claim 1 whereinthe semiconductor wafer further comprises a silicon substrate on it surface.

3. The method of claim 1 whereinthe second conductive layer and the third conductive layer in the test key area are used to detect whether pattern bridge defects exist between the fourth conductive layer and the fifth conductive layer in the active area.

4. The method of claim 1 whereinthe E-beam is generated by a scanning electron microscope (SEM).

5. A method of detecting pattern defects between two conductive layers in a test key area on a semiconductor wafer, the method comprising:
forming a first conductive layer in the test key area;
forming a dielectric layer in the test key area, the dielectric layer covering the first conductive layer;
forming a conductive plug in the dielectric layer through to the a surface of the first conductive layer;
forming a second conductive layer atop the conductive plug in the test key area, and forming a third conductive layer on the other portions of thedielectric layer in the test key area, the third conductive layer being separated from the second conductive layer by a from a distance of the second conductive layer in the test key area; and
using an E-beam to detect whether pattern bridge defects exist between the second conductive layer and the third layer;
wherein when pattern bridge defects exist between the second conductive layer and the third conductive layer, the first conductive layer, the second conductive layer, and the third conductive layer are all electrically connected; and when pattern bridge defects do not exist between the second conductive layer and the third conductive layer, only the first conductive layer and the second conductive layer are electrically connected.

6. The method of claim 5 whereinthe semiconductor wafer further comprises a silicon substrate on it surface.

7. The method of claim 5 whereinthe semiconductor wafer further comprises a plurality of active areas, and a fourth conductive layer and a fifth conductive layer are formed in each of the active areas, the fourth conductive layer and the fifth conductive layer that are being separated by with the same a distance as equal to the distance that between separates the second conductive layer and the third conductive layer are formed in each of the active areas, the second conductive layer and the third conductive layer in the test key area are being used to detect whether pattern bridge defects exist between the fourth conductive layer and the fifth conductive layer in the active area.

8. The method of claim 5 whereinthe E-beam is generated by a scanning electron microscope (SEM).

9. The method of claim 5 whereinwhen the first conductive layer, the second conductive layer, and the third conductive layer are all electrically connected, the contrasts of the first conductive layer, the second conductive layer, and the third conductive layer scanned by the scanning electron microscope are all the same, and when only the first conductive layer and the second conductive layer are electrically connected, the contrast of the second conductive layer scanned by the scanning electron microscope SEM is different from that the contrast of the third conductive layer scanned by the SEM.
